(19) United States
(12) Patent Application Publication
(10) Pub. No.: US 2012/0131559 A1
(43) Pub. Date: May 24, 2012

(54) Automatic Program Partition For Targeted Replay

(75) Inventors: Ming Wu, Beijing (CN); Fan Long, Boston, MA (US); Zhilei Xu, Boston, MA (US); Xuezheng Liu, Jersey City, NJ (US); Haoxiang Lin, Beijing (CN); Zhenyu Guo, Beijing (CN); Zheng Zhang, Beijing (CN); Lidong Zhou, Beijing (CN)

(73) Assignee: Microsoft Corporation, Redmond, WA (US)

(21) Appl. No.: 12/951,253

(22) Filed: Nov. 22, 2010

(51) Int. Cl. G06F 9/44

(52) U.S. Cl. 717/132

(57) ABSTRACT

Program partitioning of an application can include creating execution flow graphs and static flow graphs of targeted functions or operations of the application. Based on the execution flow graphs or static flow graphs, replay interfaces are created. The replay interfaces provide data flows that are usable in re-execution of the application during program development.

### BACKGROUND

During development of computer software applications, debugging is performed on the software applications. In debugging, a goal is to not only find the problem or bug, but to also find the root cause of the bug. Debugging can include reproducing behavior of the software application per certain conditions. To reproduce original or prior behavior based on the certain conditions, replay tools and techniques can be implemented.

Re-running or re-execution of a software application program can deviate from the original execution due to non-determinism from the environment, such as time, user input, and network input/output (I/O) activities.

Replay tools and techniques typically include replay interfaces. Replay interfaces are data points or values, which a software application accesses when the software application is run (re-run). In order to properly reproduce an original or prior behavior, the replay tool or technique should provide the necessary replay interfaces during run time.

A replay tool or technique should interpose or record an appropriate replay interface(s) between the software application and environment (e.g., input and output to the software application). The replay interface(s) can be recorded in a log that provides non-deterministic conditions that arise during execution. Traditional choices of replay interfaces include virtual machines, system calls, and higher level application program interfaces (API). For correctness, at the replay interface, the tool should observe all non-determinism during recording, and eliminate the non-deterministic conditions during replay, for example by feeding back recorded values or the replay interfaces from the log. Determining the replay interfaces can be problematic, because of various issues as discussed below.

Replay tools and techniques exist that are library-based and virtual machine (VM) or kernel-based; however, in many cases, such techniques can lead to significant overhead costs/expenses. Such overhead costs/expenses can include additional disk input/output (i.e., read/write to disk/memory), additional instructions to the software application and replay tool, and manual intervention to assure the correct recording and replay.

Replay techniques are valuable to debug complex applications. However, the existing replay tools, including both library-based approach and virtual machine (VM) or kernel-based approach, can introduce significant overhead during the recording phase, which is a major obstacle for the adoption of such tools in current product developing process.

### SUMMARY

This Summary is provided to introduce a selection of concepts in a simplified form that are further described below in the Detailed Description. This Summary is not intended to identify key or essential features of the claimed subject matter; nor is it to be used for determining or limiting the scope of the claimed subject matter.

Some implementations herein provide techniques for determining a targeted replay of a software application by determining target functions or operations of the program listing of the software application. In certain implementations, an execution flow graph or static flow graph is created of the program listing, where nodes of such graphs identify the targeted functions. A replay interface to re-execute the application can be created based on the graphs.

### BRIEF DESCRIPTION OF THE DRAWINGS

The detailed description is set forth with reference to the accompanying drawing figures. In the figures, the left-most digit(s) of a reference number identifies the figure in which the reference number first appears. The use of the same reference numbers in different figures indicates similar or identical items or features.

FIG. 1 is a block diagram of an example system for targeted replay according to some implementations.

FIG. 2 is an example code listing according to some implementations.

FIG. 3 is an example execution flow graph according to some implementations.

FIG. 4 is an example execution flow graph that describes function level cuts according to some implementations.

FIG. 5 is another example execution flow graph according to some implementations.

FIG. 6 is a diagram of an execution flow graph and a static flow graph that represents the execution flow graph according to some implementations.

FIG. 7 is a block diagram of an example computing device for automatic program partition for targeted replay according to some implementations.

FIG. 8 is a flow diagram of an example process for automatic program partition for targeted replay according to some implementations.

### DETAILED DESCRIPTION

This application describes automatic program partitioning for targeted replay of a software application program. Given the replay target of the application or program, the tools and techniques can automatically find an optimal replay interface to partition the application or program, enabling a deterministic targeted replay with minimum recording overhead. In particular, approximation can be performed to approximate a minimum recording overhead of targeted replay through automatic program partition, which formulates the replay of the application by finding a minimum-cut (min-cut) of a data flow graph.

In certain implementations, programming language techniques are used to automatically seek a replay interface(s) that both ensures correctness and minimizes recording overhead, and is performed by extracting data flows, estimating their recording costs via dynamic profiling, computing an optimal replay interface that minimizes the recording overhead, and instrumenting the program accordingly for interposition (i.e., re-running the program).

### Example Application and System

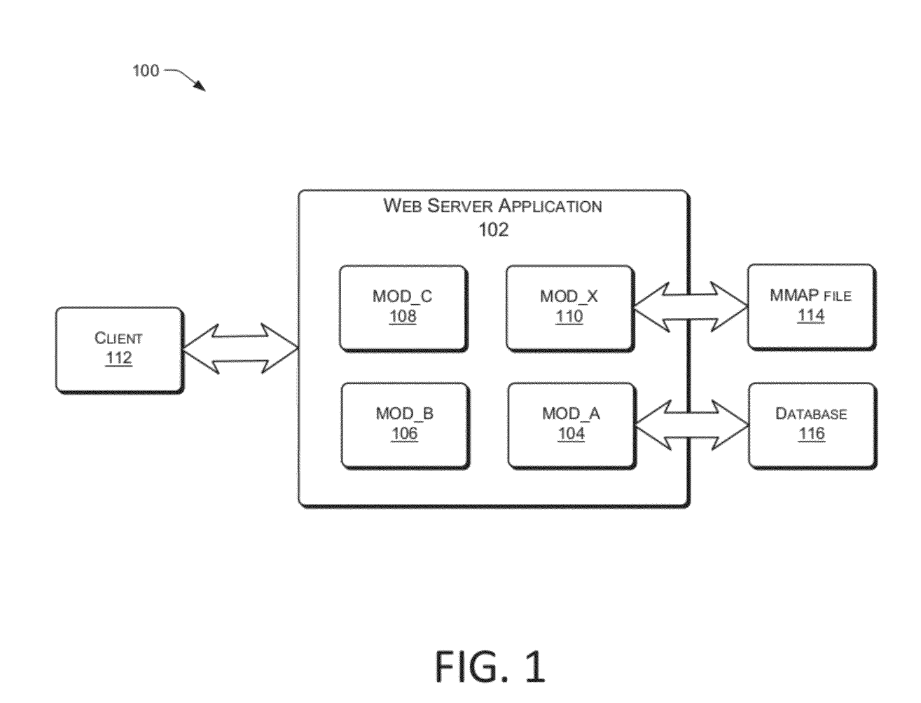

FIG. 1 shows an example system 100 that implements the described tools and techniques for targeted replay. The tools and techniques may be applied for use during development of, and in particular the debugging phase of, various software applications and programs. Examples of such applications and programs include web server applications, database applications, and complex “C” language programs. The terms “application” and “program” are understood to be interchangeable.

The tools and techniques are directed to finding a correct and low-overhead replay interface. To this end, a replay of an application's execution is determined with respect to a given replay target. A replay target is defined as the part of the application to be replayed. Therefore, behavior of the replay target during replay can be identical to that in a prior or original execution of the application. For example, the tools and techniques may analyze the source code and instrument the application during compilation, to produce a single binary executable that is able to run in either recording or replay mode.

In the example system 100, a web server or web server application 102 is shown. The web server application 102 includes a number of plug-in modules that extend functionality of the web server application 102. In particular, the web server application 102 includes the following plug-in modules: MOD_A 104, MOD_B 106, MOD_C 108, and MOD_X 108.

The server or web server application 102 communicates with the environment of system 100, such as clients (e.g., client 112), memory-mapped files (e.g., MMAP file 114), and in this example, a database server 116. In this example, the plug-in module MOD_X 110 is being developed, and is considered a replay target. MOD_X 110 can be loaded into the web server application 102 process at runtime. At times MOD_X 110 may crash at run time. Therefore, a goal is to reproduce the execution of replay target MOD_X 110 using the described tools and techniques to inspect suspicious control flows.

The described tools and techniques interpose or provide a replay interface(s) that observes non-determinism or non-deterministic effects. For example, the replay target MOD_X 110 may issue system calls that return non-deterministic results, and retrieve the contents of memory mapped files (e.g., MMAP file 114) by de-referencing pointers. To replay MOD_X 110, non-determinism is captured from both function calls and direct memory accesses. An incomplete replay interface such as one composed of only functions would result in a failed replay.

A complete interposition at an instruction level replay interface observes non-determinism, but often comes with a prohibitively high interposition overhead, because the execution of each memory access instruction is inspected. Therefore, the replay interface that is chosen is one with a low recording overhead. For example, if the logic of MOD_X 110 does not directly involve database communications, it should be safe to ignore most of the database input data during recording for replaying MOD_X 110. Recording all input to the whole process would lead to a large log size and significant slowdown. An exception may be if MOD_X 110 is tightly coupled with MOD_B 106. In other words, if MOD_X 110 and MOD_B 106 exchange a significantly large amount of data, it may be better to replay both modules together rather than MOD_X 110 alone, so as to avoid the unnecessary recording of their communications.

The tools and techniques can instrument web server application 102 based on the granularity of instructions (i.e., program level of web server application 102) for interposition at the replay interface, which can be in the form of an intermediate representation as used by the compiler(s) of the web server application 102. Such granularity may be necessary for correctly replaying web server application 102 with sources of non-determinism from non-function interfaces (e.g., memory-mapped files, such as MMAP 114).

Furthermore, and as discussed below, the tools and techniques can model the execution of web server application 102 as a data flow graph. Data flows across a replay interface are directly correlated with the amount of data to be recorded. Therefore, the replay interface with a minimal recording overhead may be determined by finding the minimum cut in the data flow graph. By doing so, the tools and techniques instrument a part of the program (i.e., MOD_X 110) and record data accordingly, which can bring down the overhead of both interposition and logging at runtime. Interposition can be through compile-time instrumentation at the chosen replay interface as the result of static analysis, thereby avoiding the execution time cost of inspecting every instruction execution.

### Execution Flow Graph

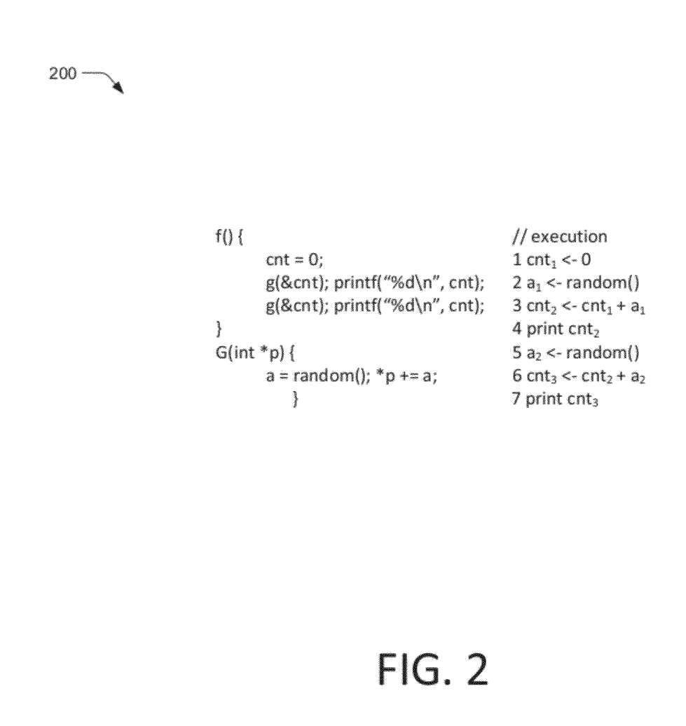

FIG. 2 shows an example partial program or code listing 200. The code listing includes a function “f” that calls function “g” twice, to increase a counter by a random number. Each variable in the execution is attached with a subscript indicating its version, which is bumped every time the variable is assigned a value, such as cnt₁, cnt₂, cnt₃ and a₁, a₂. The seven instructions in the execution sequence are labeled as Inst1 to Inst7 in the following execution flow graph.

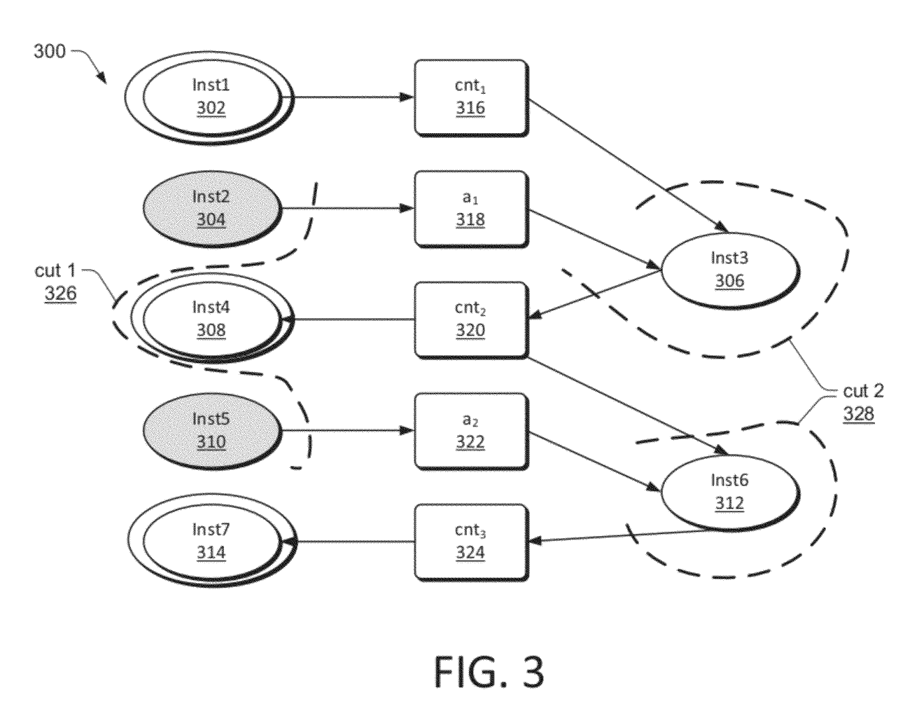

FIG. 3 shows an example execution flow graph 300. In this example, execution flow graph 300 describes the example partial code listing 200. The execution flow graph 300 is considered a bipartite graph, since it is partitioned into two subsections. The particular two subsections are function nodes and value nodes. In this example, operation or function nodes are represented by ovals. The operation or function nodes are Inst1 302, Inst2 304, Inst3 306, Inst4 308, Inst5 310, Inst6 312, Inst7 314. In this example value nodes are represented by rectangles. The value nodes are cnt₁ 316, a₁ 318, cnt₂ 320, a₂ 322, and cnt₃ 324.

Each operation or function node can have several input and output value nodes, such as connected by read and write edges, respectively. For example, as represented by the arrows, Inst3 306 reads from both cnt₁ 316 and a₁ 318, and writes to cnt₂ 320. A value node can be identified by a variable with a version number. In other words, the value node can have multiple read edges, but one write edge, for which the version number is bumped/increased. In addition, each edge can be weighted by the volume of data that flows through the edge.

As discussed, an execution flow graph represents application or program code or code listing. For example, the code listing can originate from code written by a programmer or adopted from supporting libraries. The programmer can choose part of code listing that is of interest as the replay target. A replay target corresponds to a subset of operation nodes, referred to as target nodes, in an execution flow graph. In the example of FIG. 3, the target nodes are represented by double ovals, and in particular, for the function f as represented by execution flow graph 300, the target nodes are Inst1 302, Inst4 308, and Inst7 314.

A replay is configured to reproduce an identical run of the target nodes. A replay with respect to a replay target is a run that reproduces a sub-graph that includes target nodes of the execution flow graph (e.g., execution flow graph 300), as well as their input and output value nodes. A subset of value nodes can be also be chosen as a replay target. Since an execution flow graph is bipartite, it is equivalent to choosing their adjacent operation nodes as the replay target. An assumption can be made that the replay target is a subset of operation or function nodes.

A simplified or naïve approach to reproduce a sub-graph is to record execution of all target nodes with their input and output values; however, such an approach can introduce significant and unnecessary overhead. Another approach can be to take advantage of deterministic operation or function nodes, which can be re-executed with the same input values to generate the same output. For example, assignments, such as operation or function node Inst1 302 and numerical computations, such as operation or function node Inst3 306, can be considered as deterministic. In contrast, non-deterministic operation or function nodes correspond to the execution of instructions that generate random numbers or receive external input. Such non-deterministic instructions cannot be re-executed during replay, because each run may produce a different output, even with the same input values. Examples of non-deterministic operation or function nodes are represented by filled ovals, and in particular operation or function nodes Inst2 304 and Inst5 310.

A non-deterministic operation or function node is not re-executed, in order to ensure correctness; however, the output of non-deterministic operation or function nodes, or the input of any deterministic operation or function node affected by the output of an non-deterministic operation or function node can be recorded. The recorded values can be provided during replay.

To replay target nodes correctly, target nodes should not be affected by non-deterministic nodes, as manifested as a path from a non-deterministic operation node to any of the target nodes. A replay tool can introduce a cut through that path. In this example, cut 1 326 and cut 2 328 are shown.

Such cuts define replay interfaces. Given an execution flow graph, a graph cut that partitions non-deterministic operation or function nodes from target nodes provides a valid replay interface. A replay interface can partition operation or function nodes in an execution flow graph into two sets. The set containing target nodes can be called the replay space, and the other set containing non-deterministic operation nodes can be called the non-replay space. During replay, operation or function nodes in replay space can be re-executed.

A log is performed on data that flows from non-replay space to replay space (i.e., through the cut-set edges of the replay interface), because the data are non-deterministic. Since each edge can be weighted with the cost of a corresponding read/write operation (i.e., amount of read/write or operations that flow through the edge), in order to reduce recording overhead, an optimal interface can be computed as a minimum cut. Given an execution flow graph, the minimum log size to record the execution for replay can be the maximum flow of the graph passing from the non-deterministic operation nodes to the target nodes. The minimum cut gives the corresponding replay interface.

A simple strategy for finding a replay interface is to cut non-determinism (i.e., non-deterministic nodes) whenever any appear during execution, by recording the output values of the instruction of the non-deterministic node. For example, referring back to FIG. 2, in the code listing is a non-deterministic operation referred to as “random.” Referring now to FIG. 3, cut 1 326 prevents the return values of Inst2 304 and Inst5 310 from flowing into the rest of the execution. This strategy can be used to record the values that flow through the edge between Inst2 304 and a₁ 318, and the edge between Inst5 310 and a₂ 322. In this example, Inst2 304 and Inst5 310 are in non-replay space, and the rest of the nodes are in replay space.

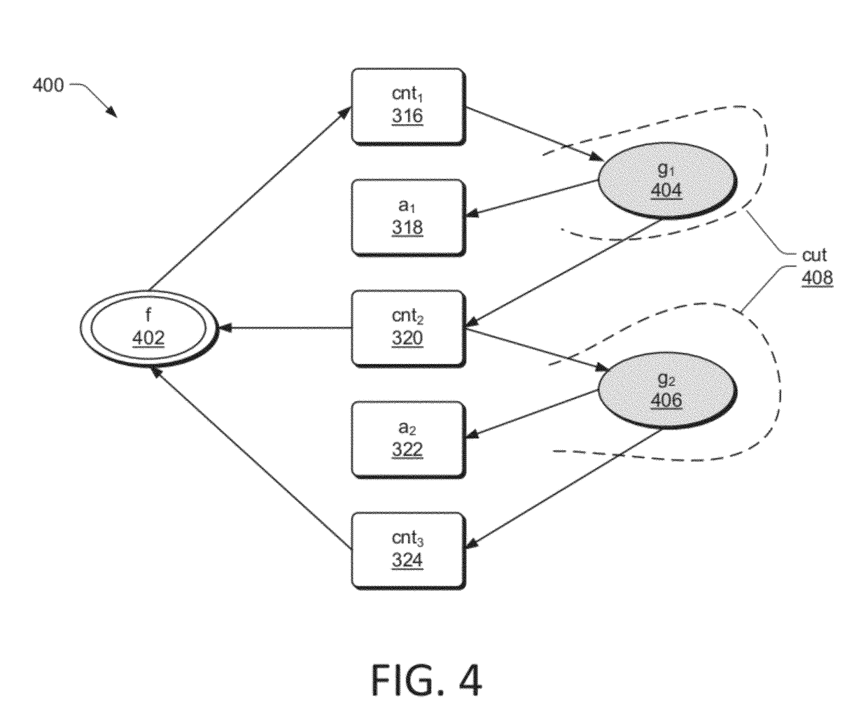

FIG. 4 shows an example execution flow graph 400 describing function level cuts. The execution flow graph 400 is further discussed below in the context of static flow graphs. An additional cut constraint can be implemented such that instructions of the same function will be either re-executed or skipped entirely. In other words, a function as a whole belongs to either replay space or non-replay space. A function-level cut can avoid switching back and forth between replay and non-replay spaces within a function.

For a function-level cut, instructions in an execution of a function are condensed into a single operation node, f 402. In this example, g₁ 404 (which includes Inst2 304 and Inst3 306 of FIG. 3) and g₂ (which includes Inst5 310 and Inst6 312 of FIG. 3) are two calls to a function g, which returns a non-deterministic value. The cut 408 corresponds to cut 328 of FIG. 3. Cut 408 can employ a strategy, which tries to cut non-determinism by recording the output whenever an execution of a function involves non-deterministic operation nodes. Such a strategy will record values that flow through the edge between g₁ 404 and cnt₂ 320, and the edge between g₂ 406 and cnt₃ 324. In this example, g₁ 404, g₂ 406, a₁ 318 and a₁ 320 are in non-replay space, and the rest of the nodes are in replay space.

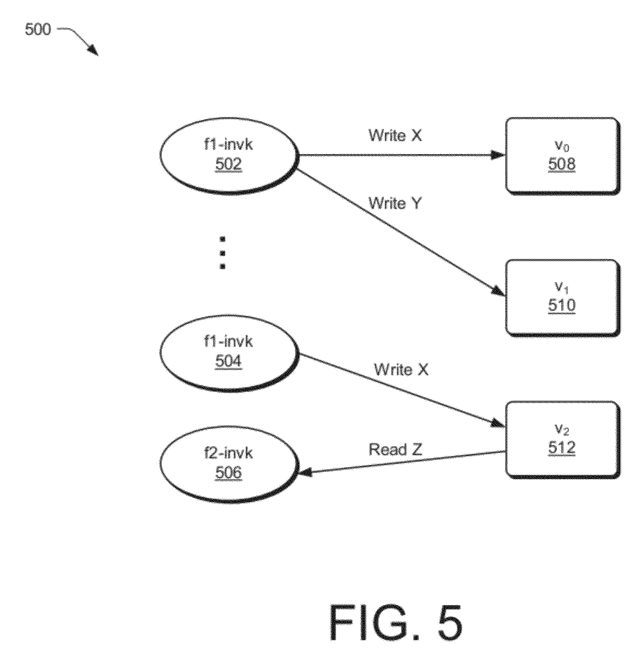

FIG. 5 shows another example of an execution flow graph 500. As discussed above, in order to enable automatic program partition, a targeted replay is defined by modeling a program execution as an execution flow graph to capture the data flow among the functions in the program. The execution flow graph includes not only function nodes corresponding to the invocations of the functions in the execution, but also value nodes to represent the actual data (or memory state) in the execution data flow between the functions. Each time a function is invoked there is a corresponding function node “f” in the graph for that invocation. The invoked functions are shown as f1-invk 502, f1-invk 504 (a different instance of f1), and f2-invk 506. Value nodes are shown as v₀ 508, v₁ 510, and v₂ 512.

In general, for a value node v corresponding to the memory state that the function invocation reads, a read edge can be formed from v to f; a write edge is formed from f to a value node v′ corresponding to the memory state to which the function writes to. Value node v is an input node of f, while the value node v′ is an output node. Because the execution flow graph models the data flow, not the control flow, it is a bipartite graph between the functions nodes and the value nodes. A value node v, can have multiple outbound read edges, but one inbound write edge.

By specifying the data flows between the function nodes and the value nodes, an execution flow graph decides not only the dependency among functions f, but also a valid partial order on the program execution. This assures that replay execution that adheres to the partial order is valid. This is particularly important for correctly replaying multi-threaded programs.

As discussed above, in certain cases it may be desirable to consider a subset of functions, referred to as the target functions. The corresponding function nodes 502, 504, and 506 in the execution flow graph 500 are referred to as the target nodes. For a given execution and its execution flow graph, a targeted replay tool should reproduce an substantially identical sub-graph that contains all the target nodes, as well as their input and output value nodes.

As discussed, non-deterministic function nodes (e.g., system calls that interact with environment, such as a receive command) may not be re-executed. If there is a path from a non-deterministic node to any of the target nodes, then a replay interface that cuts through that path should be provided. Data flow crossing the replay interface is recorded for replay.

Function invocations above the replay interface are replayed. Given an execution flow graph, values are recorded at the set of edges that cut all flows from the non-deterministic function nodes to the target nodes. These edges form the replay interface.

In order to find an optimal replay interface, a weight can be assigned to each edge to represent the cost of recording the value associated with the edge. The cost can be set to be the data size of that value. The capacity of a replay interface, defined as the sum of weights of edges belonging to the corresponding cut, can estimate the log size generated with the replay interface. Minimizing the recording cost can therefore be performed by finding the minimal cut.

### Multithreading

Thread interleaving introduces another source of non-determinism that can change from recording to replay. For example, suppose threads t1 and t2 write to the same memory address in order in an original run. It would be desirable to enforce the same write order during replay; otherwise, the value at the memory address can be different and the replay run may diverge from the original run.

To reproduce the original run, information can be recorded of the original run in two kinds of logs, a data flow log and a synchronization log with regard to thread interleaving.

The synchronization log can be produced using different techniques. One technique is to record how thread scheduling occurs in the original run. This can be performed by either serializing the execution so that only one thread is allowed to run in the replay space, or tracking the causal dependence between concurrent threads enforced by synchronization primitives (e.g., locks).

Another technique to produce a synchronization log is to record nothing in the synchronization log, employing a known deterministic multithreading model. In this case a thread scheduler behaves deterministically, so that the scheduling order in the replay run will be the same as that in the original run. Therefore, the data flow log alone can be used to reproduce the replay run.

### Static Flow Graph

With a dynamic execution flow graph, the minimal cut defines a replay interface with a minimal recording cost. Such a replay interface is best only with respect to a particular execution, which is known only after the execution is completed. A desirable replay interface should incur the minimum expected recording cost across all executions.

Therefore the execution flow graphs of an application can be summarized into one static flow graph, condensing the invocations for the same function into one representative node, and merging all the value nodes that are accessed via the same operand of an instruction. Possible data flow in an execution flow graph is mapped into a flow in the static flow graph among the corresponding functions and operands. Therefore, a replay interface that cuts all the flows from non-deterministic nodes to the target nodes in the static flow graph is an interface that can provide faithful targeted replay, since the static replay interface is a projection of possible dynamic executions.

The weight on each edge in the static flow graph is no longer the data size of the corresponding operand for an execution flow graph. The volume of the data flow on each edge can be estimated by profiling executions of the application. The replay interface corresponding to the minimum cut of the static flow graph provides a reasonable approximation to the replay interface that minimizes recording cost.

Referring back to FIG. 4, to approximate execution flow graphs statically, a static flow graph can be produced of a program via program analysis to estimate the execution flow graphs of all runs. For example, because version information of both value nodes and operation nodes may be only available during run-time rather than during compile-time, cnt1 316, cnt2 320 and cnt3 324 in the execution flow graph 400 can be projected to a single value node cnt in a static flow graph. Likewise g1 404 and g2 406 can be projected to a single operation node g. The weight of each edge can be given via runtime profiling under typical workloads as discussed below. The minimum cut of the resulting static flow graph can be computed as the recommended replay interface, which is expected to approximate the optimal replay interfaces in typical runs. Therefore, a static flow graph can be regarded as an approximation of corresponding execution flow graphs, where operation nodes are functions and value nodes are variables. The approximation should such that a cut in the static flow graph corresponds to a cut in the execution flow graph.

For example, a static analysis can be performed to construct a static flow graph from source code, as follows. The program (program listing) is scanned and an operation node is added for each function and a value node for each variable. Each instruction can be interpreted as a series of reads and writes. For example, y=x+1 can be interpreted as read x and write y. When it is discovered that a function f reading from variable x, an edge is added from x to f Similarly an edge is added from f to y if function f writes to variable y. In addition, pointer analysis can be performed, which determines variable pairs that may alias (i.e., variable pairs representing the same memory address), and merges such pairs into single value nodes.

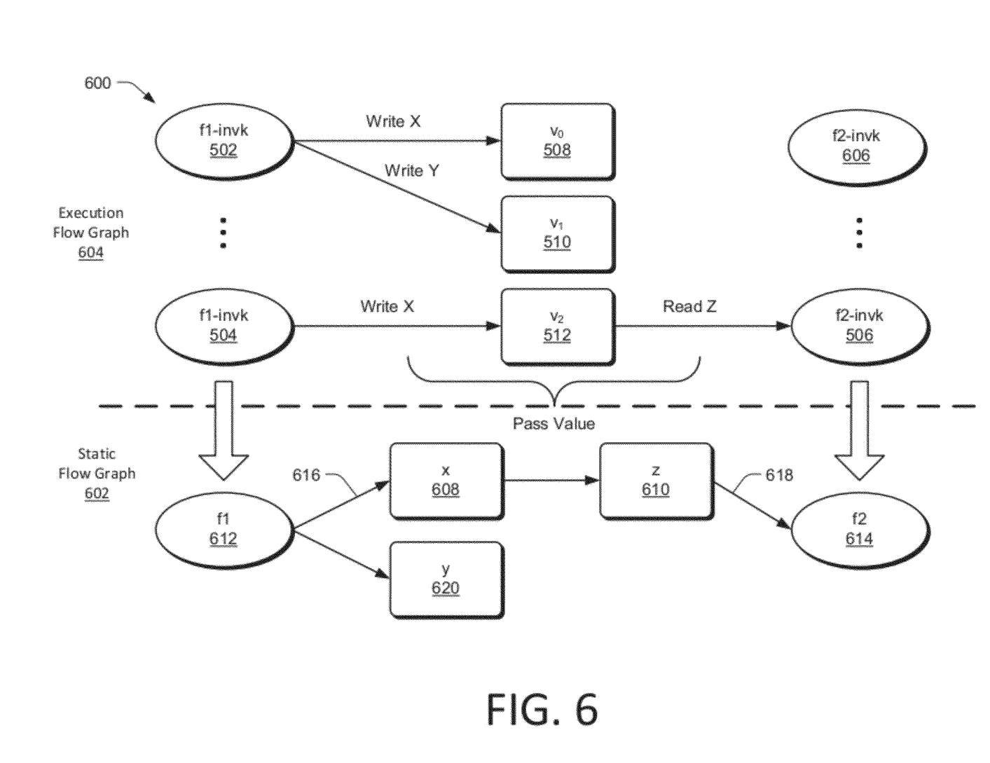

FIG. 6 shows a process 600 to construct a static flow graph 602 that summarizes execution flow graphs 604 into one graph. In this example, the static flow graph 602 is representative of the execution flow graph 500 of FIG. 5. In this representation, another instance of f2-invk is shown as f2-invk 606.

As discussed above, a static flow graph condenses the different invocations of the same functions into one function node. For a function, each read (contrast-write) instruction is represented as an inbound (contrast-outbound) edge to (contrast-from) a corresponding instruction node. The edges can be cut by instrumenting instructions at the replay interface. Furthermore, a write instruction node may pass-value to a read instruction, if the latter reads the value written by the former in a certain execution.

The directed edges in static flow graph 602 represent direction of data flows. With the pass-value relation, every flow in execution flow graph 604 is mapped to a static flow in static flow graph 602. For example, node x 608 passes value to node z 610, because of the flow via v2 512 in the execution flow graph, leading to a corresponding flow in static flow graph between f1 612 and f2 614. A cut can be made at either edge 616 or edge 618 to break the flow.

The static flow graph 602 further shows a write to node y 616 from node f1 612. Any two nodes with a pass-value edge can be merged into a single value node for the static flow graph. The pass-value relations can be approximated as alias relations, which can be created by using known alias analysis.

To find a minimized interface, edge weights may be assigned that represent quantitative estimation on data transfer at each instruction, leveraging dynamic profiling. Example implementations include the use of an instruction-level simulator to record the instructions, or through lightweight sampling. In another implementation, a profiling version of the application is built, whose memory access instructions are instrumented to count a total size of data transfers with each of them. The resulting static flow graph can be used to search various interfaces for different replay targets. A minimum cut can be performed of the static flow graph that separates the non-deterministic function nodes to the target nodes. It is to be noted that for a flow between two functions, the read edge and the write edge can have different weights. An approach is to choose the lower weight.

After generating the appropriate replay interface, memory instructions can be statically instrumented at the replay interface with record and replay callback, which can log transferred data during recording phase and are fed back during the replay phase. As to operation of an execution flow graph, causality on the memory accesses should be maintained to ensure faithful replay. To replay a multi-threaded application, identical causal orders should be enforced as to how threads access the same memory locations in a replay run as in an original or prior run.

Since tracking causal orders on every memory accesses can be involve a large overhead expensive, the following can be performed. For example for operating system (OS), synchronization events are only tracked on OS system calls (e.g., the OS application program interfaces for mutual exclusion and event operations). Also only tracked are atomic instructions on multi-processors (e.g., an atomic compare and swap). Because conflicting memory accesses by multiple threads should be protected with synchronization primitives, for typically cases tracking their causality is sufficient to reveal the causal orders on memory accesses. In an implementation, instrumenting the OS APIs and the atomic instructions is performed to record the causal events.

As discussed, construction of a static flow graph makes use of known source code of functions; however for functions without source code, such as low-level system calls, speculation can be performed as to the effects of the unknown or missing functions.

Functions without source code can be considered as non-deterministic. In other words, such functions can be placed in non-replay space. Consequently, these functions are not re-executed during replay. Therefore, the side effects of such functions should be recorded in some manner. It can be assumed that such functions can modify memory addresses reachable from parameters of the functions.

For example, for a function recv(fd; buf; len; flags), an assumption can be made that recv can modify memory reachable from buf. As a result, a cut can be made at the read edges that flow from variables affected by buf to the replay space.

### Example Computing Device

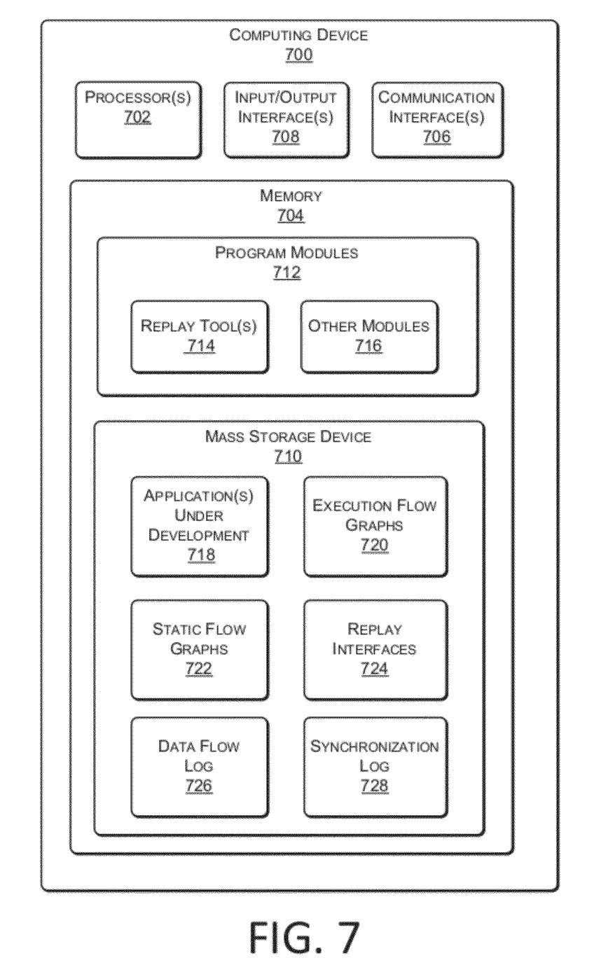

FIG. 7 illustrates an example configuration of a suitable computing system or computing device 700 for automatic program partitioning for targeted replay according to some implementations herein. It is to be understood that although computing device 700 is shown, in certain implementations, computing device 700 is contemplated to be part of a larger system. Furthermore, the described components of computing device 700 can be resident in other computing devices, server computers, and other devices as part of the larger system or network.

Computing device 700 can include at least one processor 702, a memory 704, communication interfaces 706 and input/output interfaces 708. The processor 702 may be a single processing unit or a number of processing units, all of which may include single or multiple computing units or multiple cores. The processor 702 can be implemented as one or more microprocessors, microcomputers, microcontrollers, digital signal processors, central processing units, state machines, logic circuitries, and/or any devices that manipulate signals based on operational instructions. Among other capabilities, the processor 702 can be configured to fetch and execute computer-readable instructions or processor-accessible instructions stored in the memory 704, mass storage device 710, or other computer-readable storage media.

Memory 704 is an example of computer-readable storage media for storing instructions which are executed by the processor 702 to perform the various functions described above. For example, memory 704 can generally include both volatile memory and non-volatile memory (e.g., RAM, ROM, or the like). Further, memory 1404 may also include mass storage devices, such as hard disk drives, solid-state drives, removable media, including external and removable drives, memory cards, Flash memory, floppy disks, optical disks (e.g., CD, DVD), storage arrays, storage area networks, network attached storage, or the like, or any combination thereof Memory 704 is capable of storing computer-readable, processor-executable program instructions as computer program code that can be executed on the processor(s) 702 as a particular machine configured for carrying out the operations and functions described in the implementations herein.

Memory 704 may include program modules 712 and mass storage device 710. Program modules 712 can include the above described replay tool(s) 714. The program modules 712 can include other modules 716, such as an operating system, drivers, and the like. As described above, the replay tool(s) 714 can be executed on the processor(s) 702 for implementing the functions described herein. Additionally, mass storage device 710 can include application(s) under development or application(s) 718; execution flow graphs 720 derived from the application(s) 718; static flow graphs 722 derived from the execution flow graphs 720; and replay interfaces 724. Furthermore, mass storage device 710 can include a data flow log 726 that describes the information of previous or prior runs of the application(s) 718, as well as synchronization log 728 for the prior runs of the application(s) 718.

The communication interfaces 706 can allow for exchanging data with other devices, such as via a network, direct connection, or the like. The communication interfaces 706 can facilitate communications within a wide variety of networks and protocol types, including wired networks (e.g., LAN, cable, etc.) and wireless networks (e.g., WLAN, cellular, satellite, etc.), the Internet and the like. The input/output interfaces 708 can allow communication within computing device 700.

### Example Program Partition Process

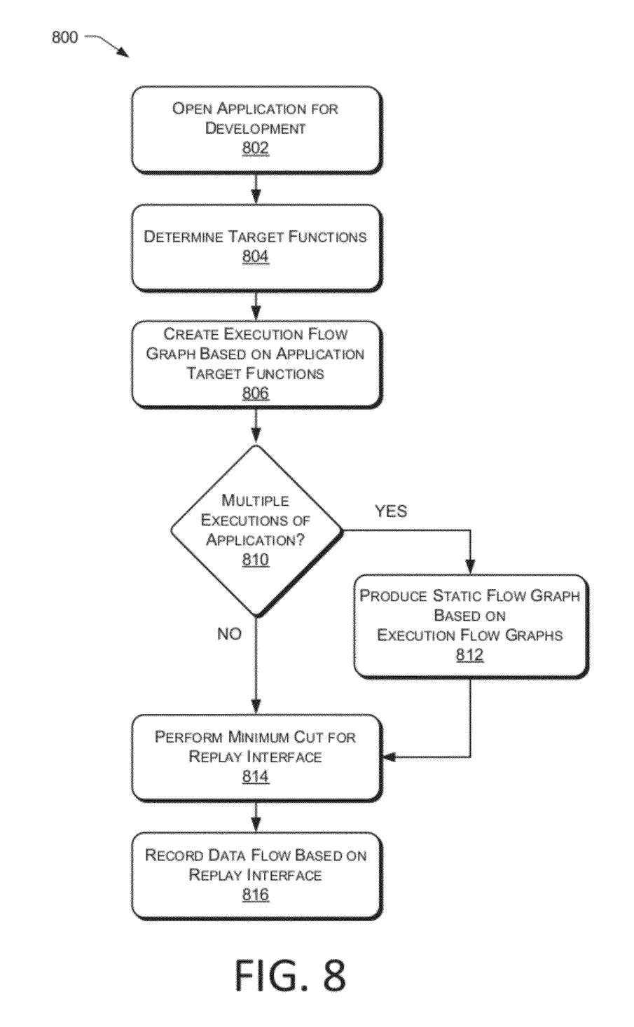

FIG. 8 depicts a flow diagram of an example of a program partition process according to some implementations herein. In the flow diagram, the operations are summarized in individual blocks. The operations may be performed in hardware, or as processor-executable instructions (software or firmware) that may be executed by one or more processors. Further, the process 800 may, but need not necessarily, be implemented using the system of FIG. 7, and the processes described above.

At block 802, an application under development is opened. Such an application is to be debugged. In particular, the application has an original or prior execution run under deterministic and/or non-deterministic conditions as described above. The particular application includes a program listing that shows operable functions and instructions.

At block 802, a determination is made as to target functions. As discussed, a particular subset of application or program listing is desired to be addressed/evaluated. Therefore, particular function targeted. The target functions are considered as targeted replay.

At block 806, an execution flow graph is created based on the application code listing. Furthermore, target nodes are identified on the execution flow graph. Nodes of the execution flow graph can include instruction or function nodes, and value nodes.

If multiple executions of the applications are performed, following the YES branch of block 810, a static graph can be produced based on the execution flow graphs or multiple execution flow graphs.

At block 814, a minimum cut across edges of an execution flow graph or static flow graph. In particular, the cut can be performed on non-deterministic nodes to target nodes of an execution flow graph or static flow graph, as described. The minimum cut provides a replay interface for the targeted replay.

At block 814, a data flow can be recorded based on the replay interface. The data flow can include a data log as well as a synchronization log as described above.

### CONCLUSION

Implementations herein provide targeted replay of a program by partitioning functions of the programs and creating replay interface for re-execution of the program. Further, some implementations address multiple executions of the program through a static flow graph.

Although the subject matter has been described in language specific to structural features and/or methodological acts, the subject matter defined in the appended claims is not limited to the specific features or acts described above. Rather, the specific features and acts described above are disclosed as example forms of implementing the claims. This disclosure is intended to cover any and all adaptations or variations of the disclosed implementations, and the following claims should not be construed to be limited to the specific implementations disclosed in the specification. Instead, the scope of this document is to be determined entirely by the following claims, along with the full range of equivalents to which such claims are entitled.

1. A method performed by one or more computing devices comprising:
opening a software application that includes a program listing;
determining target functions of the program listing;
creating an execution flow graph of the program listing, that identifies the target functions as target nodes; and
providing a replay interface based on the execution flow graph.

2. The method of claim 1, wherein the software application includes one or more plug-in modules that include the program listing.

3. The method of claim 1, wherein the determining target functions includes condensing instructions in an execution of a function to a single operation.

4. The method of claim 1, wherein the creating an execution flow graph includes function nodes and value nodes, and edges connecting read and write operations between the function and value nodes.

5. The method of claim 4, wherein a weight is assigned to the edges.

6. The method of claim 1, wherein the providing the replay interface includes capturing non-deterministic effects from the targeted functions and memory access.

7. The method of claim 1, wherein the providing the replay interface includes partitioning nodes into a replay space of the target nodes and non-deterministic function nodes in a non-replay space.

8. The method of claim 7, wherein a log is performed on data that flows from the non-replay space to the replay space.

9. The method of claim 1 further comprising producing a static flow graph based on the execution flow graph.

10. The method of claim 9, wherein edges of the static flow graph are weighted based on run time profiles.

11. A method of partitioning a program listing, under the control of a computing device configured with executable instructions comprising:
identifying target functions of the program listing for analysis;
creating an execution flow graph based on the program listing;
identifying target nodes of the execution flow graph that correspond to the target functions;
providing a replay interface that cuts edges from non-deterministic nodes of the execution flow graph; and
recording a data flow based on the replay interface.

12. The method of claim 11, wherein the program listing is part of a software application that is executed during debugging.

13. The method of claim 11, wherein the creating the execution flow graph includes assigning weights to edges connecting function nodes and value nodes of the execution flow graph.

14. The method of claim 11, wherein the identifying target nodes includes identifying non-deterministic function nodes.

15. The method of claim 11, wherein the recording the data flow includes providing a data log and sequence log.

16. The method of claim 11 further comprising producing a static flow graph of the execution flow graph and one or more execution flow graphs.

17. A computing device comprising:
one or more processors;
memory storing executable instructions that, when executed by the one or more processors, configure the one or more processors to:
access a program listing of a software application under development;
create an execution flow graph or a static flow graph based on the program listing;
provide a replay interface for the software application based on either the execution flow graph or static flow graph; and
record a data flow based on the replay interface.

18. The computing device of claim 17 further comprising a replay tool stored in the memory can executable by the one or more processors, that accesses the program listing, creates the execution flow graph or static flow graph, provides the replay interface, and records the data flow.

19. The computing device of claim 17 further comprising locations in memory for execution flow graphs, static flow graphs, and replay interfaces.

20. The computing device of claim 19 further comprising locations in memory for a data flow log and synchronization log.
